(19) United States
(12) Patent Application Publication
(10) Pub. No.: US 2019/0095621 A1
(43) Pub. Date: Mar. 28, 2019

(54) METHODS FOR MITIGATING FAULT ATTACKS IN MICROPROCESSORS USING VALUE PREDICTION

(71) Applicant: QUALCOMM Incorporated, San Diego, CA (US)

(72) Inventors: Rosario CAMMAROTA, San Diego, CA (US); Rami Mohammad A. AL SHEIKH, Morrisville, NC (US); Wenjia RUAN, Santa Clara, CA (US)

(21) Appl. No.: 15/717,434

(22) Filed: Sep. 27, 2017

(51) Int. Cl. G06F 21/56

(52) U.S. Cl. CPC G06F 21/566; G06F 2221/034; G06F 21/567

(57) ABSTRACT

Aspects of the present disclosure are directed to detecting and responding to injected faults. In some examples, fault injections are detected in a pipeline processor using transactional memory by comparing a predicted value (e.g. from a Value Predictor) against a subsequently loaded or computed reference value, and then detecting the fault based on the result of the comparison. If the predicted value is found to differ from the subsequently loaded or calculated value, the difference is deemed to be due to a fault and actions are taken to address the fault, such as by using deception or blinding of observable values. In some examples, the Value Predictor is modified to perform the comparison to detect the fault. The Value Predictor then notifies Transactional Hardware, which responds to the fault. In other examples described herein, the Value Predictor is unchanged and the Transactional Hardware detects and corrects the fault.

### TECHNICAL FIELD

The invention relates generally to computing systems and, more particularly, to methods and apparatus for detecting and mitigating malicious glitches and faults.

### BACKGROUND

Modern microprocessors use a variety of techniques to improve performance, such as caching, pipelining, speculative execution, and value dependent execution. Such techniques improve performance but can introduce artifacts in the execution of a program that can be leveraged by an attacker to extract sensitive information or bypass access control mechanisms in software. For example, to improve performance, values or addresses can be predicted by a Value Predictor before the values are actually computed or loaded from memory. The processor may then speculatively execute instructions based on the predicted value. If the prediction is correct, the processor uses the speculative results, thereby gaining a performance advantage over processors that do not include such predictive techniques. If the prediction is wrong, the processor flushes the results.

However, these mechanisms have security implications. Some optimization techniques may introduce artifacts in the execution of a program that can be leveraged by an attacker to extract sensitive information or bypass access control mechanisms in software. For example, value dependent execution during caching may expose covert side-channels. Pipelined execution may facilitate fault attacks by bypassing traditional features such as instruction duplication and triplication. Hence, faults can be injected into processors by an attacker to reveal sensitive information, such as cryptographic keys, or to bypass software access control. Indeed, for cryptographic applications, fault attacks can significantly reduce the strength of the encryption to render the encryption useless or nearly so. In particular, so-called “gentle glitches” can be injected into a modern pipeline processor in which a short pulse is injected by an attacker with a pulse width set based on critical path pipeline delays to corrupt data without causing a noticeable fault. Other faults triggered by longer pulses may be referred to as focused faults or traditional single faults. Recent studies have asserted it may not be possible to adequately mitigate fault attacks in modern processors in software (see, e.g., Yuce et. al. Software Fault Resistance is Futile: Effective Single-Glitch Attacks. FDTC 2016, DOI: 10.1109/FDTC.2016.21).

An attack model of particular concern is one where the attacker determines precisely when and where a fault should be injected in a pipeline to obtain sensitive information. This may be achieved by using micro-benchmarking to generate a profile of a particular processor design to ascertain the timing of critical sections of each instruction in hardware. Armed with that information, the attacker may launch attacks on cloud servers or other devices that use the same processor, either by exploiting physical access to the device or, in some cases, exploiting remote row hammer attacks or the like.

Improved fault and glitch mitigation would be advantageous.

### SUMMARY

A method for detecting a fault injected during operation of a processor includes: predicting a value using a value prediction component of the processor; comparing the predicted value against a reference value using a comparison component of the processor to detect a misprediction of the value; and detecting a fault injected during operation of the processor using a fault detection component of the processor based on the misprediction of the value.

In another aspect, a computing device includes: a processing circuit configured to predict a value, compare the predicted value against a reference value to detect a misprediction of the value, and detect a fault injected during operation of the processor based on the misprediction of the value.

In yet another aspect, an apparatus for detecting a fault injected during operation of a processor includes: means for predicting a value; means for comparing the predicted value against a reference value to detect a misprediction of the value; and means for detecting a fault injected during operation of the processor based on the misprediction of the value.

In still yet another aspect, a non-transitory computer readable medium having instructions stored thereon is provided for controlling a processor to: predict a value using a value prediction component of the processor; compare the predicted value against a reference value using a comparison component of the processor to detect a misprediction of the value; and detect a fault injected during operation of the processor using a fault detection component of the processor based on the misprediction of the value.

### BRIEF DESCRIPTION OF THE DRAWINGS

FIG. 1 is a block diagram illustrating an exemplary Value Predictor.

FIG. 2 is a block diagram illustrating an exemplary multiple-core processor.

FIG. 3 is a block diagram illustrating exemplary transactional memory processing.

FIG. 4 illustrates a first general exemplary method to detect and correct a fault based on a value misprediction.

FIG. 5 illustrates a second general exemplary method to detect and correct a fault based on a value misprediction.

FIG. 6 illustrates further aspects the first general exemplary method for use when a single prediction is mispredicted.

FIG. 7 illustrates further aspects the first general exemplary method for use when two or more related predictions are mispredicted.

FIG. 8 illustrates further aspects the second general exemplary method for use when a single prediction is mispredicted.

FIG. 9 illustrates further aspects the second general exemplary method for use when two or more related predictions are mispredicted.

FIG. 10 illustrates a first general exemplary processor for use with the exemplary method of FIG. 4 to detect and correct a fault based on a value misprediction.

FIG. 11 illustrates a second general exemplary processor for use with the exemplary method of FIG. 5 to detect and correct a fault based on a value misprediction.

FIG. 12 illustrates an exemplary server or wireless device, in which aspects of the present disclosure may be implemented.

FIG. 13 illustrates exemplary components of the processor of FIG. 12.

FIG. 14 broadly illustrates an exemplary method for use by a processor for detecting a fault.

FIG. 15 further illustrates an exemplary method for use by a processor for detecting and correcting a fault.

### DETAILED DESCRIPTION

Aspects of the present disclosure are directed to detecting and mitigating faults injected into the processors, especially faults that affect the hardware operation of the processor, such as clock glitches or the like. Although particular aspects are described herein, many variations and permutations of these aspects fall within the scope of the disclosure. Although some benefits and advantages of are mentioned, the scope of the disclosure is not intended to be limited to particular benefits, uses, or objectives. Rather, aspects of the disclosure are intended to be broadly applicable to different technologies, system configurations, networks, and protocols, some of which are illustrated by way of example in the figures and in the following descriptions. The detailed description and drawings are merely illustrative of the disclosure rather than limiting, the scope of the disclosure being defined by the appended claims and equivalents thereof.

### Overview

In various examples described herein, malicious fault injections are detected in a processor by (1) comparing a predicted value (e.g. from a Value Predictor) against a subsequently loaded or computed reference value, and then (2) detecting the fault based on the result of the comparison. That is, if the predicted value is found to differ from the subsequently loaded or calculated value, the difference is deemed to be due to a fault and actions are taken to address the fault, such as by using deception or blinding. (Ordinarily, mispredictions simply trigger a flush of the pipeline rather than fault processing.) Note that predictions provided by Value Predictors are often quite accurate, e.g. 99.9% accurate, and so the “failure” of the prediction is more likely due to an injected fault than an incorrect prediction. If the prediction is indeed simply an incorrect prediction, any speculative processing performed based on the incorrect prediction is flushed anyway.

Some Value Predictors make multiple related predictions, such as by predicting both an address and a register value and, in some examples described herein, the handling of the fault depends on whether more than one related prediction is made. For example, with one prediction, a fault is detected. With two or more related predictions, the fault is detected and corrected. Herein the faults that are detected and mitigated are primarily maliciously injected faults, especially faults that affect the hardware operation of the processor, such as clock glitches, voltage changes, temperature changes, or the like. Hence, herein a fault that affects the hardware operations of a processor is a fault that affects, changes or otherwise influences clock parameters, voltage parameters, thermal parameters, or other electrical or physical operations or characteristics of the processor. However, in some examples, other types of faults may be detected as well.

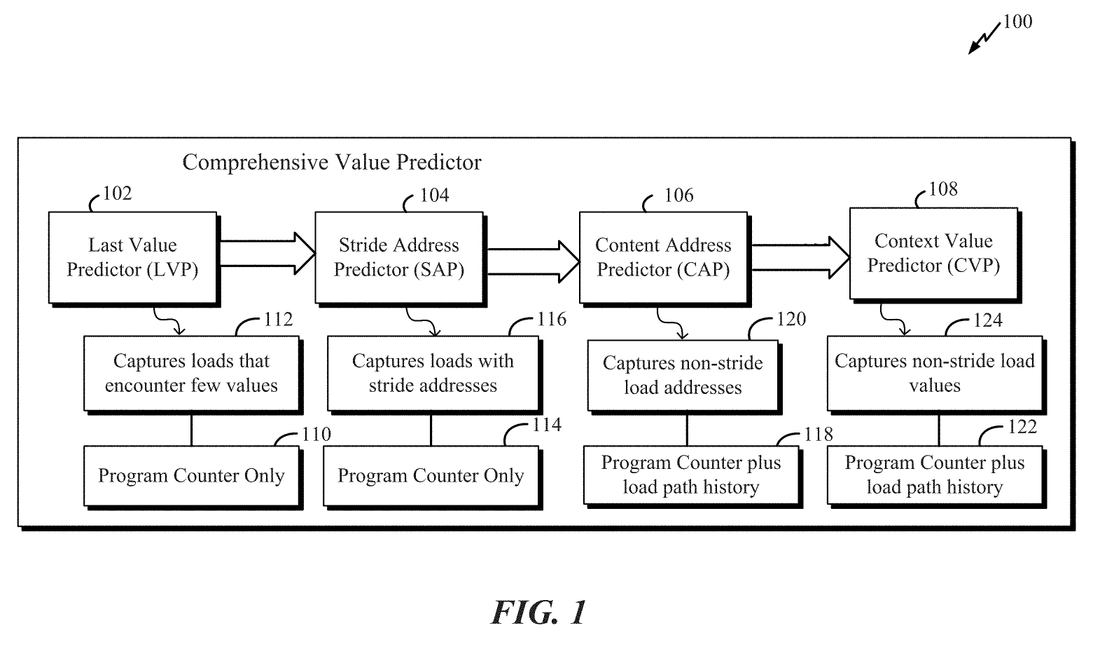

FIG. 1 illustrates an exemplary comprehensive value predictor 100 that may be used to predict values, which are then exploited to detect and, if possible, correct faults. The value predictor 100 of FIG. 1 includes four main stages or components: a last value predictor (LVP) 102, a stride address predictor (SAP) 104, a context address predictor (CAP) 106, and a context value predictor (CPV) 108.

The LVP 102 may be configured with a single table (not separately shown) containing data values indexed based on a program counter (PC). Each entry in the table may include the last value of an instruction that links to that particular entry. The latest value output from the table is the prediction. That is, in a common LVP configuration example, the prediction simply consists of predicting that the new value will be the same value as the last time the same instruction was executed. Often, this simple prediction proves accurate. As shown by block 110, the LVP 102 operates on PC's only and, as shown by block 112, the LVP 102 serves to capture instruction loads that encounter few new values (i.e. the LVP is most successful in predicting values in circumstances where the instructions process the same values and hence yield the same result).

The SAP 104 may be configured to predict that the effective address of an instruction load will be a fixed stride (i.e. a fixed offset) from the effective address that the load yielded the last time the instruction was executed (where a stride refers to the displacement between two elements in memory). The SAP 104 is thus particularly effective for array accesses in which an instruction load works through (i.e. sequences through) different elements of an array. As shown by block 114, the SAP 104 operates on PC's only and, as shown by block 116, the SAP 104 serves to capture loads with stride addresses (i.e. the SAP is most successful in predicting values in circumstances where instructions share common stride lengths).

The Context Address Predictor 106 may be configured to predict the effective address of a load based on a history of prior address processed by the load. In this regard, loads often cycle through or sequence through a fixed pattern of addresses. Hence, the CAP 106 is often effective with recursive data structures. The CAP 106 can also successfully capture some of the addresses that are predicted accurately by the LVP 102 and the SAP 104. As shown by block 118, the CAP 106 operates on PC's and on load path history and, as shown by block 120, the CAP 106 serves to capture loads with addresses that are non-strides (i.e. the CAP can predict values in circumstances where instructions do not share common stride lengths).

The CVP 108 may be similar to the CAP 106 but configured to predict the load values rather than address values (based on a history of prior branches). As shown by block 122, the CVP 108 operates on PC's and on branch history and, as shown by block 124, the CVP 108 serves to capture loads with non-stride values (i.e. the CVP can predict values in circumstances where instructions do not share common stride lengths).

Using the components of FIG. 1, a value stored in a register and/or a memory location may be successfully predicted ahead of instruction execution. These prediction techniques often work well for workloads that have value locality or predictable value patterns and often work especially well on cryptographic implementations.

As noted, faults may be injected into processors, including those that incorporate the value prediction components. One fault of particular concern is a so-called “gentle fault,” which may be triggered in a modern processor by a malicious attacker by selectively exposing a precise location within the microprocessor at a precise time to a laser pulse or the like to trigger a brief clock glitch. A gentle fault is engineered to work on modern microprocessors based on a characterization of the microprocessor, which may be obtained using micro-benchmarking. The techniques herein mitigate gentle faults, as well as other faults, such as focused faults or traditional single faults. Note that, as the term is used herein, “gentle glitches” are a specific case of gentle faults, in which a short pulse is injected within a single clock cycle. Another example of gentle fault is an engineered fault that uses a short and focused laser pulse to perturb the pipeline at a certain stage on a certain instruction.

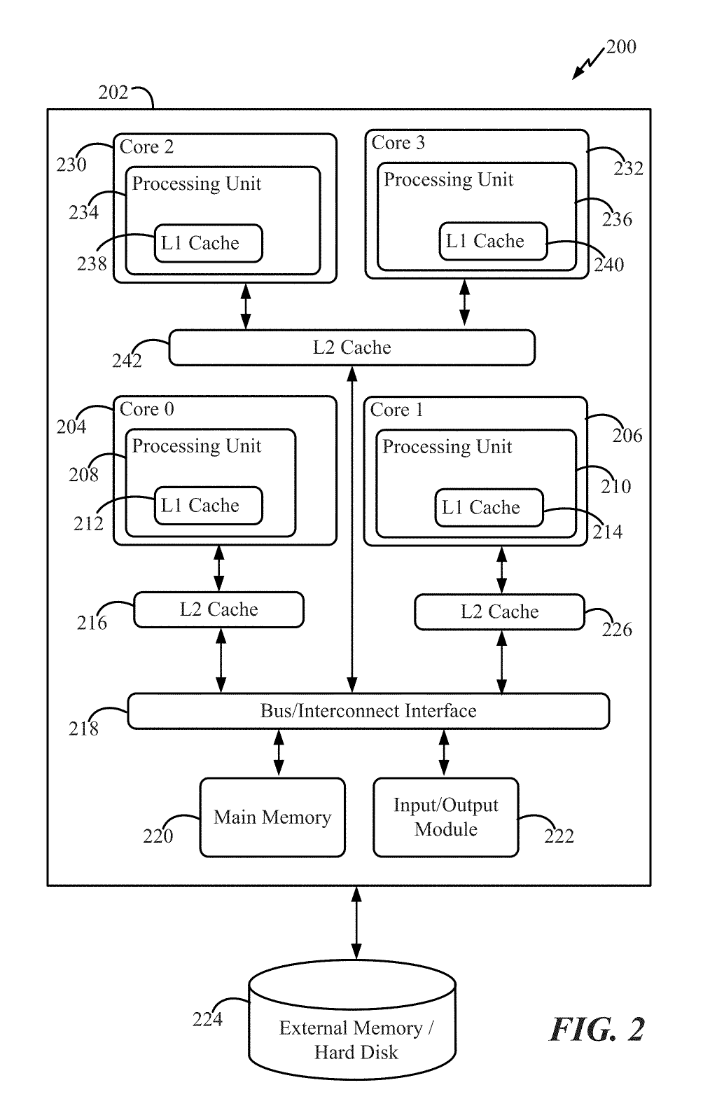

FIG. 2 illustrates an exemplary multicore processor architecture 200 in which the value prediction components of FIG. 1 may be implemented. A multicore processor 202 may include two or more independent processing cores 204, 206, 230, 232 on a single substrate, die, integrated chip, etc. In this example, the multicore processor 202 includes a multi-level cache that includes Level 1 (L1) caches 212, 214, 238, 240 and Level 2 (L2) caches 216, 226, 242. The multicore processor 202 also includes a bus/interconnect interface 218, a main memory 220, and an input/output module 222. The L2 caches 216, 226, 242 may be larger (and slower) than the L1 caches 212, 214, 238, 240, but smaller (and faster) than a main memory unit 220. Each processing core 204, 206, 230, 232 includes a corresponding processing unit 208, 210, 234, 236 that has private access to a respective one of he L1 caches 212, 214, 238, 240. The processing cores 204, 206, 230, 232 may share access to an L2 cache (e.g., L2 cache 242) or may have access to an independent L2 cache (e.g., L2 cache 216, 226).

The L1 and L2 caches may be used to store data frequently accessed by the processing units such as to store transactional memory for use in speculative processing, whereas the main memory 220 may be used to store larger files and data units accessed by the processing cores 204, 206, 230, 232. The multicore processor 202 may be configured so the processing cores 204, 206, 230, 232 seek data from memory in order, first querying the L1 cache, then L2 cache, and then the main memory if the information is not found in the caches. If the information is not found in the caches or the main memory 220, multicore processor 202 may seek information from an external memory and/or a hard disk memory 224. The processing cores 204, 206, 230, 232 communicate with each other via the bus/interconnect interface 218. Each processing core 204, 206, 230, 232 may have exclusive control over some resources and share other resources with other cores. The processing cores 204, 206, 230, 232 may be identical to one another, be heterogeneous, and/or implement different specialized functions. Thus, processing cores 204, 206, 230, 232 need not be symmetric, either from the operating system perspective (e.g., the processors may execute different operating systems) or from the hardware perspective (e.g., the processors may implement different instruction sets/architectures).

As noted, the caches of the system of FIG. 2 may be used to implemented transactional memory. Briefly, transactional memory may serve to simplify concurrent programming by allowing a set of load and store instructions to execute with atomicity. Atomicity relates to the isolation from interrupts, signals, concurrent processes and threads and is relevant to thread safety and reentrancy. Additionally, atomic operations are often “succeed-or-fail,” i.e. the operations either change the state of the system successfully, or have no apparent effect. Transactional memory may be regarded as a concurrency control mechanism similar to database transactions that control access to shared memory in concurrent computing. Transactional memory systems may provide a high level of abstraction as an alternative to low level thread synchronization. The high level of abstraction may permit coordination between concurrent reads and writes of shared data in parallel systems, and hence is useful in multiprocessor systems, particularly those that employ speculative processing, including value predictive systems.

Within processor systems such as the system of FIG. 2, a short glitch within a particular clock cycle may result in corruption of data so as to expose sensitive information stored within one of the caches. In particular, attacks using short glitches may be launched against processors that employ transactional memory in hardware. Within such processors, a set of instructions may be executed speculatively in a transaction. The transaction is aborted if an invalid condition is detected, otherwise values are posted, following an “all-or-nothing” property. Often, the processor uses a cache coherence protocol to detect conflicts/invalid condition. (An example of transactional memory is described in “Transactional Memory Support,” U.S. Patent Application 2017/0017583 of ARM Limited (Cambridge, Cambridgeshire, and GB).

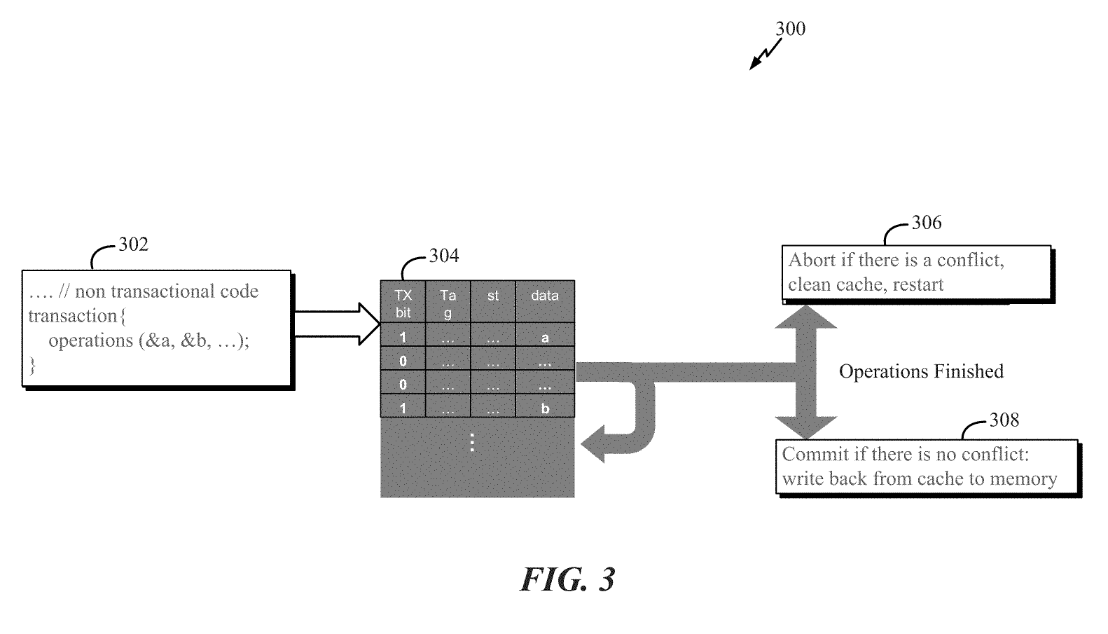

FIG. 3 illustrates exemplary hardware support 300 for transactional memory in a reduced instruction set computing (RISC) architecture. Briefly, in a first block 302, non-transactional code is used to pull all accessed data from memory to a cache. Block 304 illustrates an exemplary cache. During speculative execution, all results are kept in the cache. Upon detection of a conflict, the processor keeps tracking the code if an address is also in another processor's cache (i.e. a cache coherence protocol is employed). At 306, if there is a conflict, the cache is cleaned and restarted. At block 308, if there is no conflict, data is written back from the cache of block 304 to memory to commit any speculative values within the cache to memory.

Within processors employing the components and techniques discussed above, or within other suitable processors, malicious fault injections may be detected by comparing a predicted value against a subsequently loaded or computed reference value, and then detecting the fault based on the result of the comparison. That is, a policy is implemented whereby a value misprediction is assumed to be the result of a fault, rather than the result of a simple misprediction. Further policies specify the handling of the detected fault.

In a first general exemplary method, the Value Predictor is modified to perform the fault detection. The Value Predictor then notifies the separate transactional processor hardware of the fault. This first method can serve to mitigate both gentle faults and focused single faults. In a second general exemplary method, the Value Predictor is unchanged, and the comparison between the predicted value and the loaded value is performed in separate hardware. The second method serves to mitigate gentle faults.

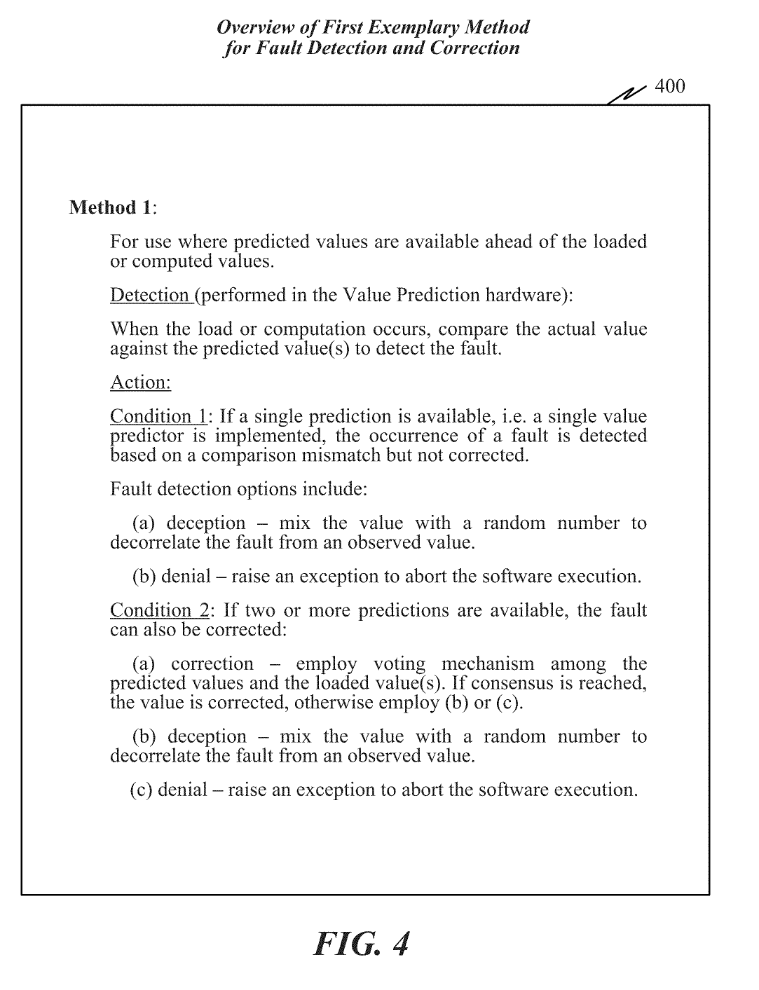

FIG. 4 summarizes the first exemplary method (i.e. Method 1) 400 where the Value Prediction is enhanced or modified to compare a loaded or computed value (that is used as a prediction reference value) against the predicted value(s). In this example, predicted values are available ahead of loaded or computed values.

### Method 1:

Detection (occurs in the Value Prediction hardware):
   When the load or computation occurs, the actual value is produced, and a comparison against the predicted value is used to detect the fault.
Action:
   Condition 1: If a single prediction is available, i.e. only one value predictor is implemented, then the occurrence of a fault is detected, but not corrected. Possible actions to fault detection include:
      (a) deception—raise an exception to a fault handler to mix the value with a random number to decorrelate the fault from the observed value.
      (b) denial—raise an exception to abort the software execution.
   Condition 2: If two or more predictions are available, then the fault can also be corrected:
      (a) correction—employ voting mechanisms among the predicted values and the loaded value. If consensus is reached, the value is corrected, otherwise (b) or (c) is implemented.
      (b) deception—raise an exception to a fault handler to mix the value with a random number to decorrelate the fault from the observed value.
      (c) denial—raise an exception to abort the software execution.

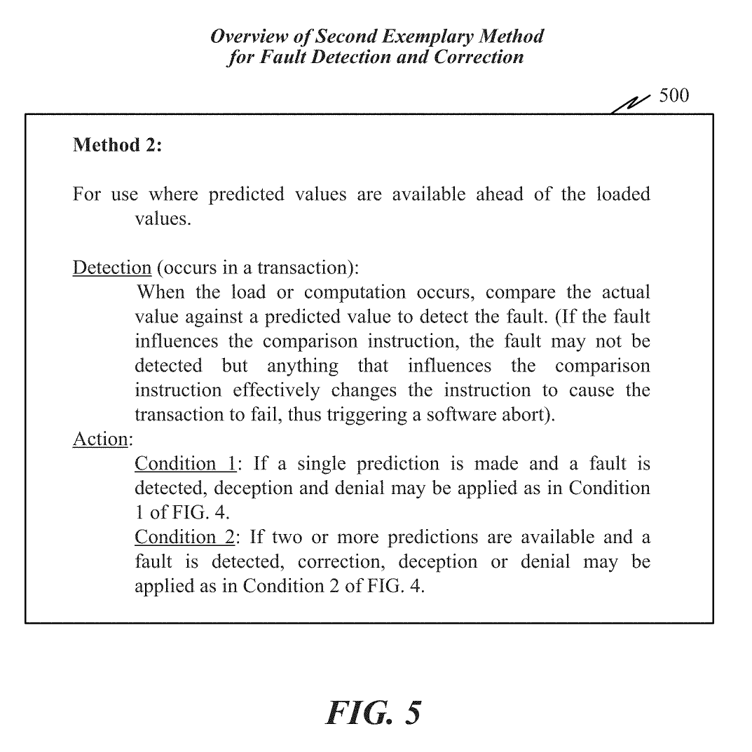

FIG. 5 summarizes the second exemplary method (i.e. Method 2) 500 where value prediction scheme is unchanged from that of FIG. 1, with the load and the comparison executed in a transaction in hardware. This procedure may be used to mitigate gentle faults (but not necessarily focused faults). In this example, predicted values are available ahead of the loaded values.
Detection (occurs in a transaction):
   When the load occurs, the actual value is loaded, and a comparison to test the presence of a fault is used to detect the fault. (If the fault influences the comparison instruction, the fault may not be detected but anything that influences the comparison instruction effectively changes the instruction to cause the transaction to fail, thus triggering a software abort).
Action:
   Condition 1: If a single prediction is made and a fault is detected, deception and denial are applied as in Condition 1 above.
   Condition 2: If two or more predictions are made and a fault is detected, correction, deception and denial may be applied as in Condition 2 above.

In either case, by exploiting mispredictions made by the value predictor to detect possible faults, attacks of the type described above where the attacker determines precisely when and where a fault should be injected may be thwarted. Note that Method 2 operates on loaded values but not computed values, whereas Method 1 may operate on either loaded values or computed values. This is because when the Value Predictor makes its predictions, the predicted values are available to the Value Predictor ahead of (i.e. before) the corresponding values are loaded or computed. Hence, the procedure of Method 1 may exploit either loaded or computed values during its comparison. However, when the comparison is made within the Transactional Hardware in accordance with Method 2, computed values may not be available at the time the comparison is made.

Relatively modest changes may be made to processor designs to implement the policies of Methods 1 or 2, i.e. to treat a misprediction as a fault. For example, an additional control signal may be employed to switch the Value Predictor from its standard mode of operation of a security mode where mispredictions are treated as faults. A simple state machine may be employed that specifies the handling of mispredicted values (e.g., whether the values should be mixed with random numbers for deception or “blinding”). In one example, the security mode of the Value Predictor is only activated for certain instructions pertaining to access control mechanisms and cryptographic operations.

A feature of either of the two main fault handling techniques (Methods 1 or 2) is that a significant reduction in processing overhead can be achieved as compared to processors that would otherwise provide instruction duplication or triplication for error detection, since fewer loads may be needed when implementing the procedures of Methods 1 or 2, which do not employ such duplication or triplication. An exemplary load performed by transactional hardware that uses duplication is as follows:

| | |
|---|---|
| ld | [%fp - 12], %g2 |
| ld | [%fp - 12], %g3 |
| cmp | %g2, %g3 |
| bne | .alarm |

However, with Method 1, the transactional hardware omits the duplication and simply performs the load once (since misprediction comparison is done in the Value Predictor):

ld [% fp-12], % g2

With Method 2, the transactional hardware performs the prediction comparison:

| | |
|---|---|
| xbegin | // transaction starts |
| ld | [%fp - 12], %g2 |
| cmp | %g2, %g3 |
| xend | // transaction ends |

In the following section, exemplary methods are discussed in greater detail.

### Exemplary Implementations

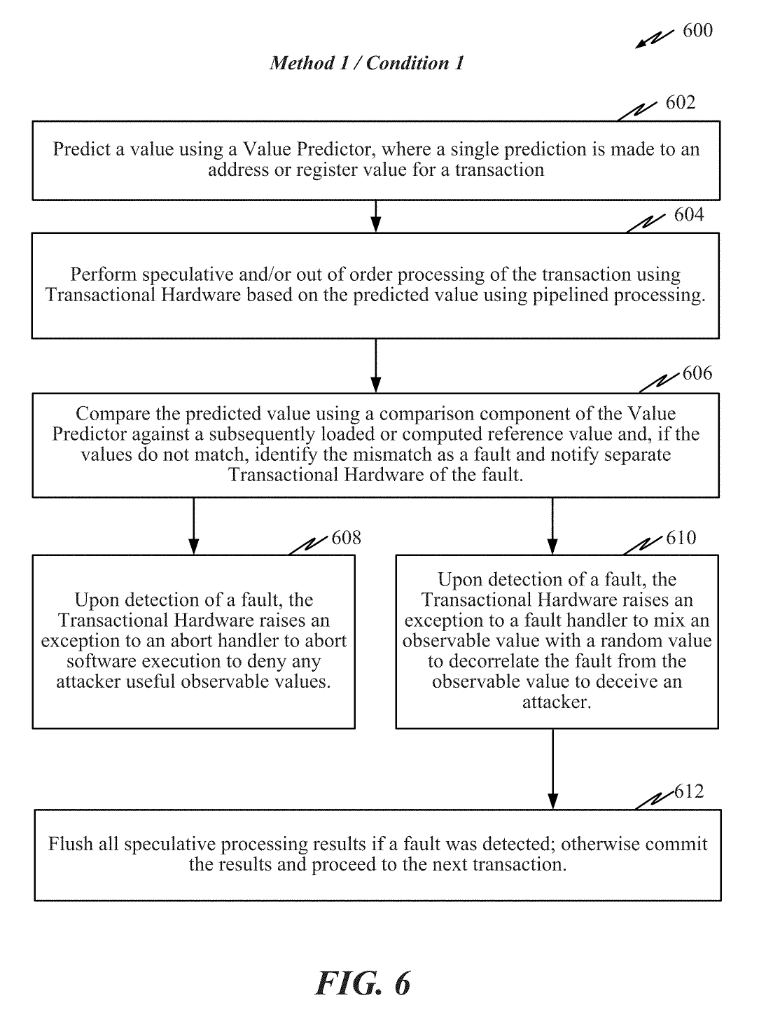

FIG. 6 illustrates an exemplary procedure 600 in accordance with Condition 1 of Method 1 of FIG. 4, i.e. a process where a Value Predictor detects the fault based on a single predicted value (rather than based on two or more related predictions). At 602, the Value Predictor predicts a value, such as by predicting a register value using the LVP 102 of FIG. 1 or by predicting an address using the SAP 104 of FIG. 1, where a single prediction is made for a particular instruction. At 604, speculative and/or out of order processing of the transaction is performed by transactional hardware (or other suitable components of a processor) based on the predicted value using pipelined processing. At 606, the predicted value is compared using a comparison component of the Value Predictor against a subsequently loaded or computed value (i.e. a prediction reference value) and, if the values do not match, the mismatch is deemed to be a fault (i.e. the mismatch is identified or otherwise associated with a fault as a matter of policy) and the separate Transactional Hardware is notified of the fault. Since the fault may be a malicious fault induced by an attacker, further steps of denial or deception are performed.

At 608, upon detection of a fault, the Transactional Hardware raises an exception to an abort handler to abort software execution to deny the attacker useful observable values. By aborting the software, an attacker monitoring observable values via side channels or the like will not likely detect useful values triggered by their fault injection, such as value that might permit accessing sensitive information. Alternatively, at 610, upon detection of a fault, the Transactional Hardware raises an exception to a fault handler to mix an observable value with a random value to decorrelate the fault from the observable to deceive an attacker. The random value may be obtained from a pseudo-random number generator (PRNG) of other suitable device. The observable value to be mixed with a random number may be, e.g., the loaded or computed value that is fed to the next step in the pipeline. By mixing the observable value with a random number, any attacker monitoring observable values in a speculative pipeline via side channel leakage or the like will only detect a randomized number.

At 612, all speculative processing results are flushed if a fault was detected at 606 and deception was applied at 610. Otherwise the results are committed at 612 and processing proceeds to the next transaction. Note that, since the observable value that was mixed with a random value at 608 was part of a speculative transaction, that value and any other values generated from that value will be flushed from the pipeline at 612 and hence will not adversely affect further processing. That is, the randomized observable value of block 610 will not be used in any committed transaction and hence will not present a problem to the proper execution of the software. Note also that, after block 608, flushing of the pipeline due to the fault is not needed since the software itself is aborted.

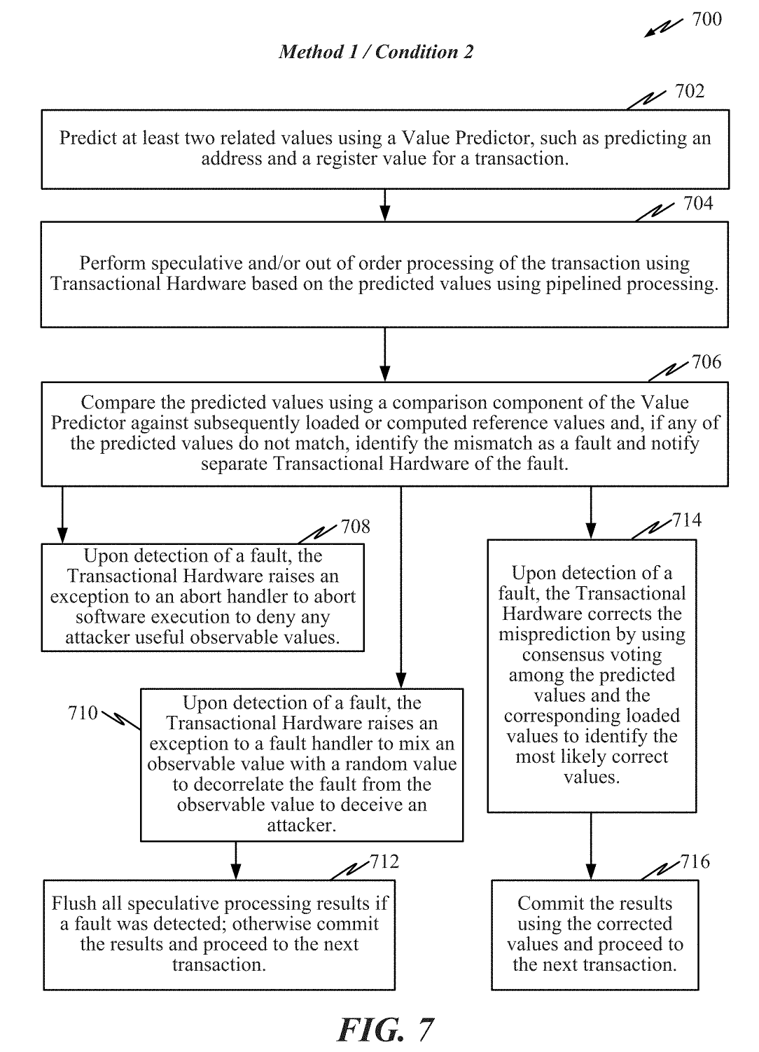

FIG. 7 illustrates an exemplary procedure 700 in accordance with Condition 2 of Method 1 of FIG. 4, i.e. a process where the Value Predictor detects the fault based on two or more related mispredicted values. At 702, at least two related values are predicted for a transaction (such as by predicting both an address and it corresponding register value), and/or by making multiple predictions to an address or a register value by using different prediction components (such as by making separate address predictions using the SAP 104 and the CAP 106 of FIG. 1). At 704, speculative and/or out of order processing of the transaction is performed by Transactional Hardware based on the predicted values using pipelined processing. At 706, the predicted values are compared using a comparison component of the Value Predictor against subsequently loaded or computed reference values and, if any of the predicted values do not match, the mismatch is deemed to be a fault (i.e. the mismatch is identified or otherwise associated with a fault as a matter of policy) and the separate Transactional Hardware is notified of the fault.

At 708, as in FIG. 6, upon detection of a fault, the Transactional Hardware raises an exception to an abort handler to abort software execution to deny any attacker useful observable values. At 710, as with FIG. 6, the Transactional Hardware alternatively raises an exception to a fault handler to mix an observable value with a random value to decorrelate a detected fault from the observable value to deceive an attacker. At 712, all speculative processing results are flushed if a fault was detected at 706 and deception was applied at 710. Otherwise the results are committed at 710 and processing proceeds to the next transaction.

As an additional alternative, at 714, the Transactional Hardware may attempt to correct the misprediction. For example, upon detection of a fault at 706, the Transactional Hardware seeks to correct the misprediction by using consensus voting among the predicted values and the corresponding loaded values to identify the most likely correct values. For example, if two related address predictions were made that conflict with the loaded address (i.e. there are two predicted values and one loaded value), a correction component of the Transactional Hardware may determine if two of the three values match one another. If so, the two values found to match are deemed to correspond to the correct value. And so, for example, if two address predictions match but the subsequently loaded address is different, the correction component deems the loaded address to be wrong (possibly due to an injected fault) and the matching predicted address to be correct. The correction component then ignores the loaded address and instructs other components to use the predicted value. As another example, if one of the predicted addresses matches the loaded address, but the other predicted address does not match, the loaded address is then deemed to be correct. This procedure is regarded herein as a type of “consensus voting” since each of the different values (predicted or loaded) has a “vote” in determining which value is correct. As can be appreciated, more sophisticated forms of consensus voting may be used, especially if there are a larger number of predicted values. Following correction of the misprediction, the speculative results are committed at 716 using the corrected value. If the correction was in error, the transaction will likely soon fail and the software will be aborted.

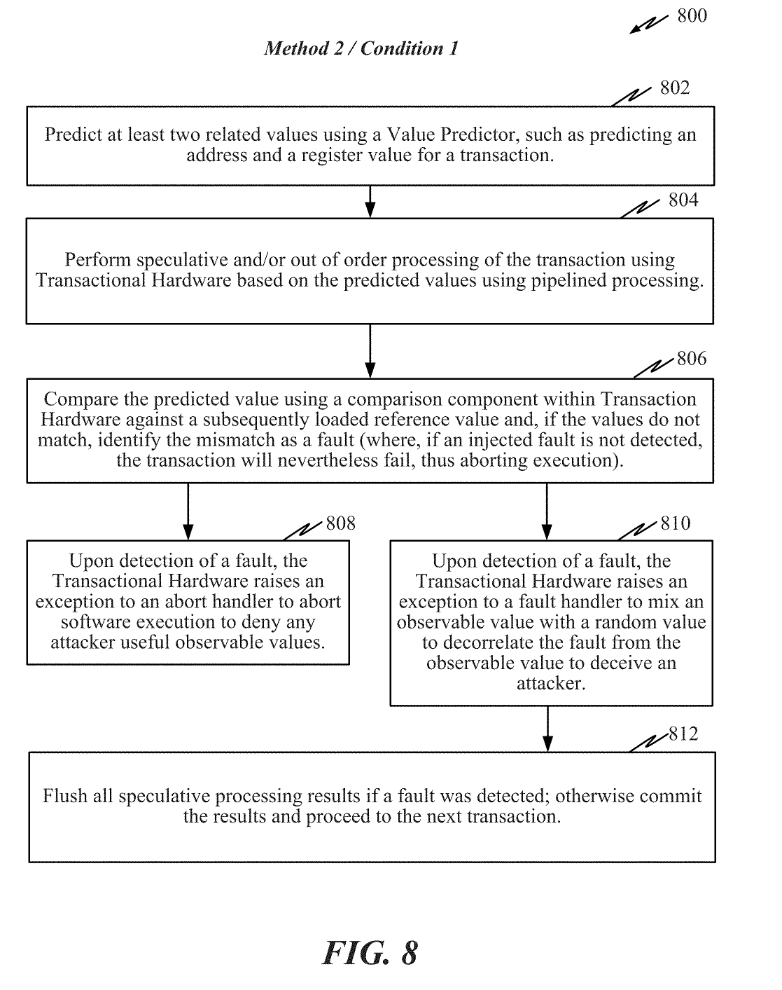

FIG. 8 illustrates an exemplary procedure 800 in accordance with Condition 1 of Method 2 of FIG. 5, i.e. a process where the Value Predictor is unchanged and the Transactional Hardware is configured to detect the fault based on a single mispredicted value. At 802, a value is predicted, such as by predicting a register value using the LVP 102 of FIG. 1 or predicting an address using the SAP 104 of FIG. 1, where a single prediction is made for a transaction. At 804, speculative and/or out of order processing of the transaction is performed by Transactional Hardware based on the predicted value using pipelined processing. At 806, the predicted value is compared using a comparison component of the Transactional Hardware against a subsequently loaded reference value and, if the values do not match, the mismatch is deemed to be a fault (i.e. the mismatch is identified or otherwise associated with a fault as a matter of policy). Note that if a fault arises in the operation of the Transactional Hardware itself, the comparison might not be trustworthy. That is, the comparison might wrongly misreport two matching values as mismatched values. Or, the comparison might fail to detect to values that are actually mismatched and thus misreport the values as being the same. However, in these situations, the transaction will nevertheless fail, thus aborting execution with little risk of exposure of sensitive information.

At 808, upon detection of a fault, as with FIGS. 6 and 7, the Transactional Hardware of FIG. 8 can raise an exception to an abort handler to abort software execution to deny any attacker useful observable values. At 810, and as with FIGS. 6 and 7, upon detection of a fault, the Transactional Hardware alternatively raises an exception to a fault handler to mix an observable value with a random value to decorrelate the fault from the observable value. At 812, all speculative processing results are flushed if a fault was detected at 806 and deception was applied at 810. Otherwise the results are committed at 812 and processing proceeds to the next transaction.

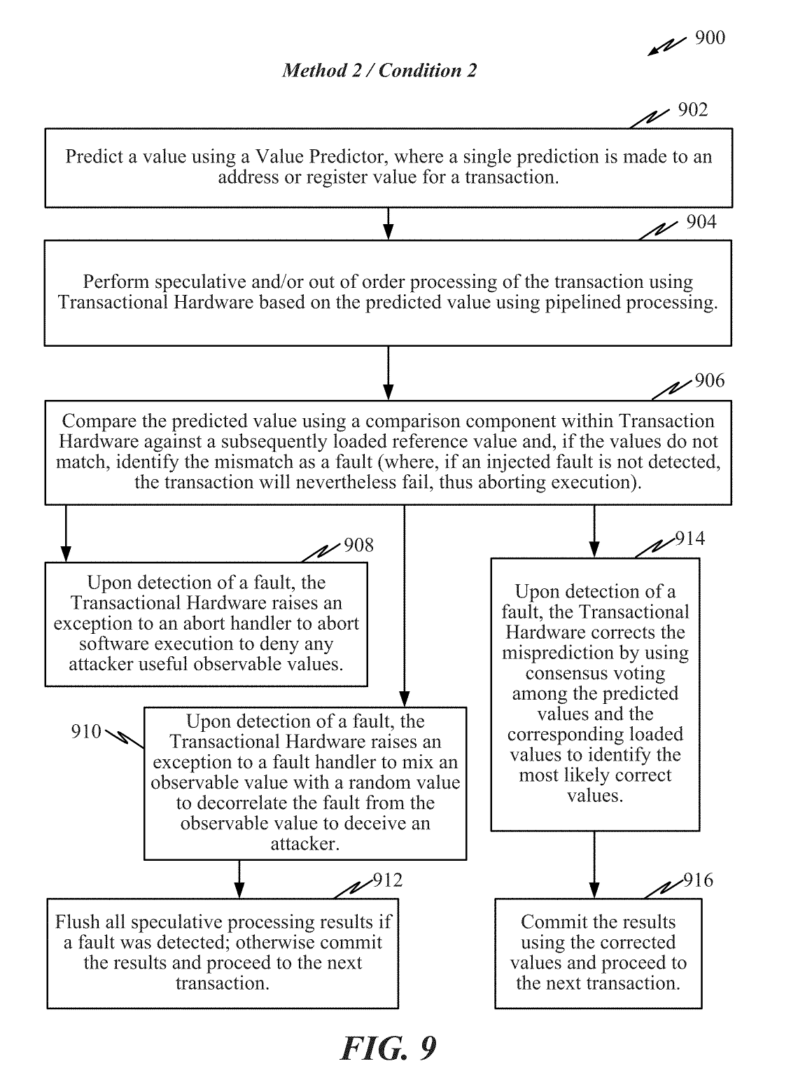

FIG. 9 illustrates an exemplary procedure 900 in accordance with Condition 2 of Method 2 of FIG. 5, i.e. a process where the Transactional Hardware detects and corrects a fault based on two or more related mispredicted values. At 902, at least two related values are predicted for a transaction by the Value Predictor (as in FIG. 6). At 904, speculative and/or out of order processing of the transaction is performed by Transactional Hardware based on the predicted values using pipelined processing. At 906, the predicted values are compared using a comparison component of the Transactional Hardware against subsequently loaded reference values and, if any of the predicted values do not match, the mismatch is identified as (or otherwise associated with) a fault.

At 908, as in FIG. 8, upon detection of a fault, the Transactional Hardware raises an exception to an abort handler to abort software execution. Alternatively, at 910, as with FIG. 8, the Transactional Hardware raises an exception to a fault handler to mix an observable value with a random value to decorrelate a detected fault from the observable value to deceive an attacker. At 912, all speculative processing results are flushed if a fault was detected at 906 and deception was applied at 910. Otherwise the results are committed at 912 and processing proceeds to the next transaction.

As a further alternative, at 914, the Transactional Hardware may attempt to correct the misprediction (using the same techniques discussed above in connection with FIG. 8). That is, upon detection of a fault at 906, the Transactional Hardware seeks to correct the misprediction by using consensus voting among the predicted values and corresponding loaded values to identify the most likely correct values. Following correction of the misprediction, the speculative results are committed at 916 using the corrected value. If the correction was in error, the transaction will likely soon fail and the software will be aborted.

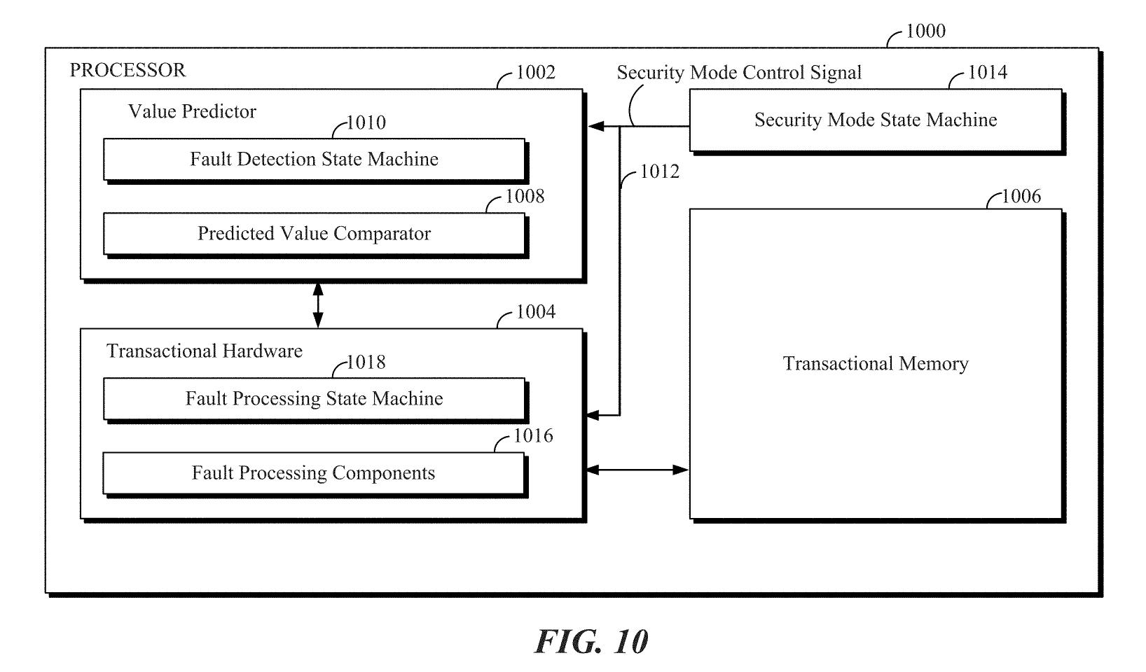

FIG. 10 broadly summarizes components for use with Method 1. A processor 1000 includes a Value Predictor 1002, Transactional Hardware 1004 and Transactional Memory 1006. The Value Predictor 1002 includes a Predicted Value Comparator 1008 for comparing predicted values against loaded or computed reference values and a Fault Detection State Machine 1010 for activating and controlling the Predicted Value Comparator 1008 based on a current value of a Security Mode Control Signal 1012 received from a Security Mode State Machine 1014 to detect faults. For example, the Security Mode State Machine 1014 may activate the security mode of the Value Predictor 1002 using the control signal whenever the Value Predictor needs to predict values that affect cryptographic operations or access control operations.

In the security mode, the Value Predictor 1002 employs its Predicted Value Comparator 1008 to compare predicted values against loaded or computed reference values and then notifies the Transactional Hardware of any mispredictions, as already discussed. When not in the security mode, the Predicted Value Comparator 1008 is inactive and the Value Predictor 1002 operates in an otherwise routine mode of operation to predict values for use by the Transactional Hardware. The Transactional Hardware 1004 also receives the Security Mode Control Signal 1012 and, when the Security Mode is activated, the Transactional Hardware 1004 employs Fault Processing Components 1016 to perform the aforementioned Deception, Denial and/or Correction operations in response to any mispredictions (which are interpreted as a matter of policy as a fault). The Transactional Hardware 1004 also includes a Fault Processing State Machine 1018 that activates and controls the operations of the Fault Processing Components 1016 based on value of the Security Mode Control Signal 1012 and other factors or parameters.

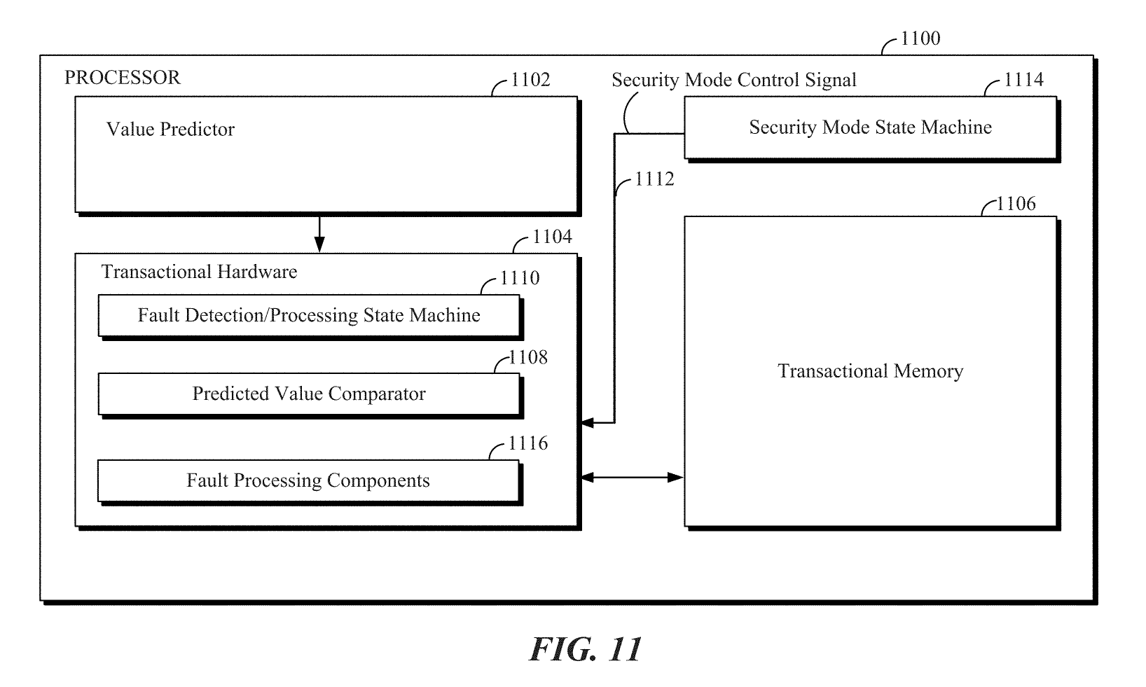

FIG. 11 broadly summarizes components for use with Method 2. As with FIG. 10, a processor 1100 includes a Value Predictor 1102, Transactional Hardware 1104 and Transactional Memory 1106. In this example, the Value Predictor 1102 is unmodified and does not include a Value Comparator or a Fault Detection State Machine. Rather, the Transactional Hardware 1004 includes a Predicted Value Comparator 1108 for comparing predicted values against loaded reference values and a Fault Detection/Processing State Machine 1010 for activating and controlling the Predicted Value Comparator 1108 based on a current value of a Security Mode Control Signal 1112 received from a Security Mode State Machine 1114 to detect faults. The Security Mode State Machine 1114 may activate the security mode of the Transactional Hardware 1104 using the control signal whenever the Transactional Hardware receives predicted values from the Value Predictor 1102 that affect cryptographic operations or access control operations.

In the security mode, the Transactional Hardware 1104 employs its Predicted Value Comparator 1108 to compare predicted values against loaded values and to treat any mispredictions as faults, as already discussed. Also, when the Security Mode is activated, the Transactional Hardware 1104 employs Fault Processing Components 1116 to perform the aforementioned Deception, Denial and/or Correction operations in response to any mispredictions. The Fault Detection/Processing State Machine 1110 activates and controls the operations of the Fault Processing Components 1116 based on value of the Security Mode Control Signal 1112 and other factors or parameters. When not in the security mode, the Predicted Value Comparator 1108 is inactive and the Transactional Hardware 1104 operates in an otherwise routine mode of operation.

It should be understood that, although FIGS. 10 and 11 illustrates various functional components such as state machines, many of these components may be implemented with minimal hardware changes to predecessor processor designs.

### Additional Exemplary Systems and Methods

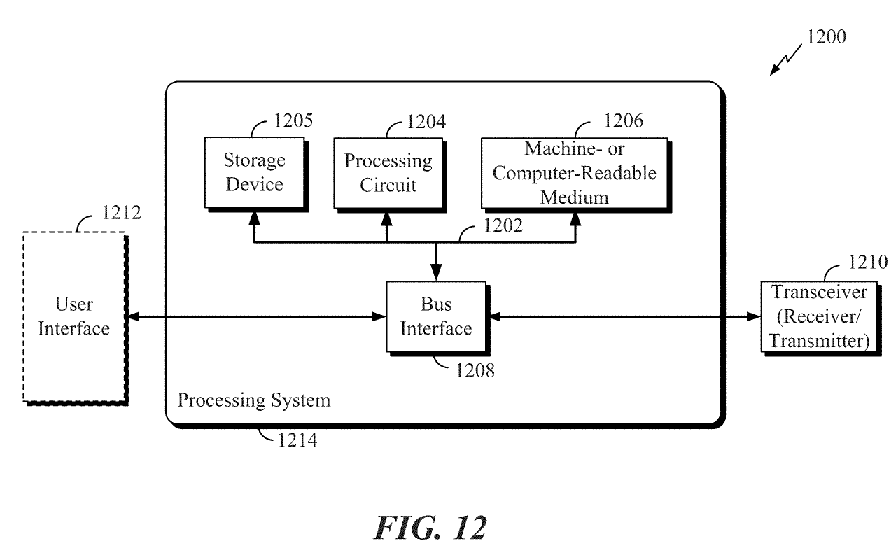

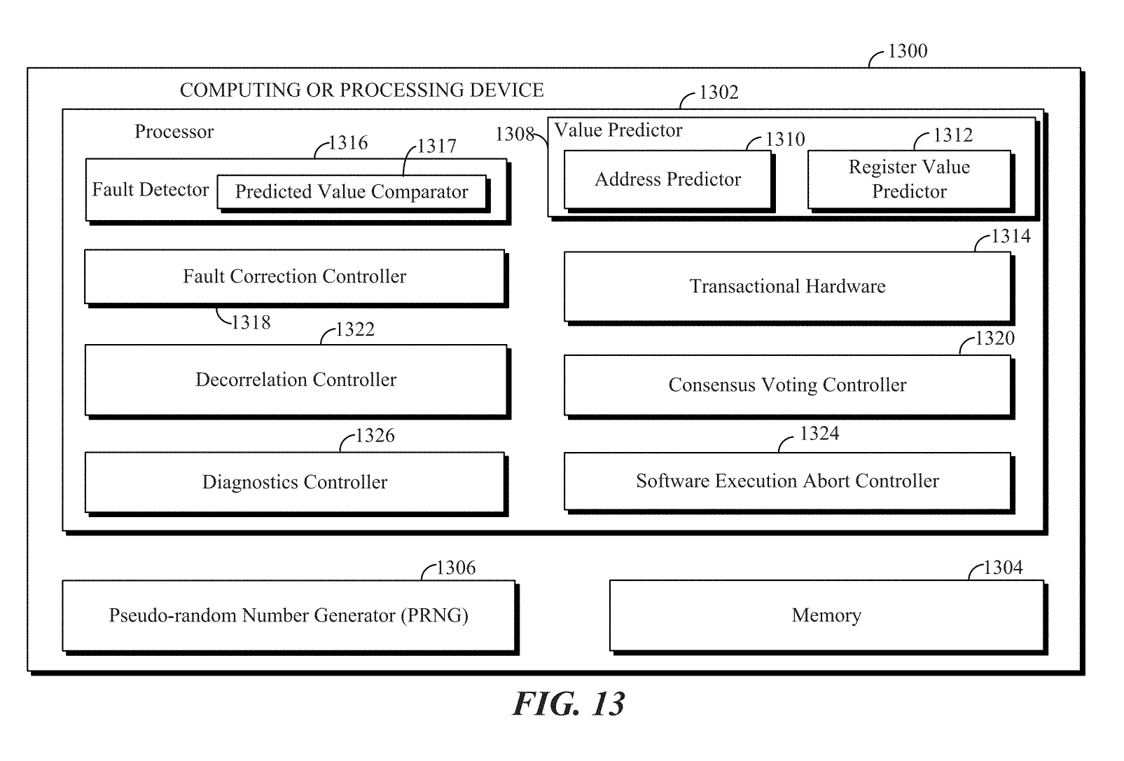

FIG. 12 illustrates an overall system or apparatus 1200 in which at least some of the systems, methods and apparatus of FIGS. 1-11 may be implemented. In accordance with various aspects of the disclosure, an element, or any portion of an element, or any combination of elements may be implemented with a processing system 1214 that includes one or more processing circuits 1204. For example, apparatus 1200 may be a cloud server or a user equipment (UE) of a mobile communication system where the UE is a smartphone equipped for wireless communication with external devices. If implemented as a smartphone or similar device, the apparatus 1200 may be used with a radio network controller (RNC). Examples of processing circuits 1204 that might be configured to implement processing features described herein include microprocessing circuits, microcontrollers, digital signal processing circuits (DSPs), field programmable gate arrays (FPGAs), programmable logic devices (PLDs), state machines, gated logic, discrete hardware circuits, a System-on-a-Chip (SoC), and other suitable hardware configured to perform the various functionality described throughout this disclosure. That is, the processing circuit 1204, as utilized in the apparatus 1200, may be used to implement aspects of any one or more of the processes described above and illustrated in FIGS. 1, 2, 3, 4, 5, 6, 7, 8, 9, 10 and 11 (and those illustrated in FIGS. 13, 14 and 15, discussed below).

In the example of FIG. 12, the processing system 1214 may be implemented with a bus architecture, represented generally by bus 1202. The bus 1202 may include any number of interconnecting buses and bridges depending on the specific application of the processing system 1214 and the overall design constraints. The bus 1202 links various circuits including one or more processing circuits (represented generally by the processing circuit 1204), the storage device 1205, and a machine-readable, processor-readable, processing circuit-readable or computer-readable media (represented generally by a non-transitory machine-readable or computer-readable medium 1206). The bus 1202 may also link various other circuits such as timing sources, peripherals, voltage regulators, and power management circuits, which are well known in the art, and therefore, will not be described any further. The bus interface 1208 provides an interface between bus 1202 and a transceiver 1210. The transceiver 1210 provides a means for communicating with various other apparatus over a transmission medium. Depending upon the nature of the apparatus, a user interface 1212 (e.g., keypad, display, speaker, microphone, joystick) may also be provided but is not required.

The processing circuit 1204 is responsible for managing the bus 1202 and for general processing, including the execution of software stored on the machine-readable medium 1206. The software, when executed by processing circuit 1204, causes processing system 1214 to perform the various functions described herein for any particular apparatus. Machine-readable medium 1206 may also be used for storing data that is manipulated by processing circuit 1204 when executing software.

One or more processing circuits 1204 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 1206. The machine-readable medium 1206 may be a non-transitory machine-readable medium or computer-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 1206 may reside in the processing system 1214, external to the processing system 1214, or distributed across multiple entities including the processing system 1214. The machine-readable medium 1206 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

The various illustrative logical blocks, modules, circuits, elements, and/or components described in connection with the examples disclosed herein may be implemented or performed with a general purpose processing circuit, a digital signal processing circuit (DSP), an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

Hence, in one aspect of the disclosure, processing circuit 1204 illustrated in FIG. 12—or components thereof—may be a specialized processing circuit (e.g., an ASIC)) that is specifically designed and/or hard-wired to perform the algorithms, methods, and/or blocks described in FIGS. 1, 2, 3, 4, 5, 6, 7, 8, 9, 10 and 11 (and those illustrated in FIGS. 13, 14 and 15, discussed below). Thus, such a specialized processing circuit (e.g., ASIC) may be one example of a means for executing the algorithms, methods, and/or blocks described in FIGS. 1, 2, 3, 4, 5, 6, 7, 8, 9, 10 and 11 (and those illustrated in FIGS. 13, 14 and 15, discussed below). The machine-readable storage medium may store instructions that when executed by a specialized processing circuit (e.g., ASIC) causes the specialized processing circuit to perform the algorithms, methods, and/or blocks described herein.

FIG. 13 illustrates selected and exemplary components of a computing or processing device 1300 having a processor 1302 adapted for predicting values and treating mispredictions of values as fault detections. In the example of FIG. 13, the computing system 1300 also includes a memory 1304, which may include transactional memory, and a PRNG 1306 for providing random or pseudorandom numbers for use in decorrelating observable values in circumstances where a fault is identified or for other purposes. The processor 1302 includes a Value Predictor 1308 for predicting a value using an Address Predictor 1310 or a Register Value Predictor 1312 (and/or other components such as those shown in FIG. 1) for use with Transactional Hardware 1314. A Fault Detector 1316 is operative to detect a fault by, e.g., comparing the predicted value against a loaded or computed reference value using a Predicted Value Comparator 1317. As already explained, in some examples, fault detection is performed by a modified version of a Value Predictor. In other examples, fault detection is performed by components of Transactional Hardware. FIG. 13 shows the fault detector 1316 as a separate component for generality.

The processor 1302 of FIG. 13 also includes a Fault Correction Controller 1318 operative to correct a detected fault based on values (if two or more related values are predicted). Correction may exploit consensus voting under the control of a Consensus Voting Controller 1320. A Decorrelation Controller 1322 is provided to mix an observable output value with another value to decorrelate a detected fault from the observable value. Components 1318, 1320 and 1322 may be components of Transactional Hardware, and are shown separately for generality. A Software Execution Abort Controller 1324 is provided to abort software in cases, if desired as a response to a fault detection. Diagnostics pertaining to fault detections or other issues may be recorded under the control of a diagnostics controller 1326.

It should be understood that, although FIG. 13 illustrates various functional components such as controllers and comparators, many of these components may be implemented with minimal hardware changes to predecessor processor designs.

Thus, in at least some examples, the computing device 1300 includes components operative to: predict a value; and detect a fault by comparing the predicted value against a reference value. Components may be provided to mix an observable output value with another value to decorrelate a detected fault from the observable value, where the observable output value is mixed with a random number to provide a deceptive result. Components may be provided to selectively abort software execution if a fault is detected. At least two related values may be predicted and, if so, components are equipped to correct a detected fault based on the related values, using, e.g., consensus voting. The predicted related values may include a predicted address and a predicted register value. In some examples, the fault is detected by the value predictor, which then notifies the separate transactional hardware of the fault. In other examples, the fault is detected by the separate transactional hardware.

Note that the various components of FIG. 13 may be replaced with a suitable means for performing or controlling the corresponding operations. Hence, in at least some examples, a device or apparatus includes: means (1308) for predicting a value; means (1317) for comparing the predicted value against a reference value to detect a misprediction of the value; and means (1316) for detecting a fault injected during operation of the processor based on the misprediction of the value. Means (1322) may be provided for mixing an observable output value with another value to decorrelate a detected fault from the observable value. Means for aborting software execution (1324) may be provided for use if a fault is detected. The means for predicting a value may include means (1310, 1312) for predicting at least two related values and where the apparatus further comprises means (1318) for correcting a detected fault based on the related values. The means for correcting the detected fault based on the predicted related values may comprise means (1320) for determining a correct value based on the predicted related values using consensus voting.

Still further the various components of FIG. 13 may be represented, in some examples, as a set of instructions for controlling a programmable device to perform the corresponding operations. Hence, in at least some examples, instruction are provided for controlling a processor to: predict a value using a value prediction component of the processor; compare the predicted value against a reference value using a comparison component of the processor to detect a misprediction of the value; and detect a fault injected during operation of the processor using a fault detection component of the processor based on the misprediction of the value. Additional instructions may be provided for: mixing an observable output value with another value to decorrelate a detected fault from the observable value; aborting software execution if a fault is detected; predicting at least two related values; correcting a detected fault based on the related values using consensus voting.

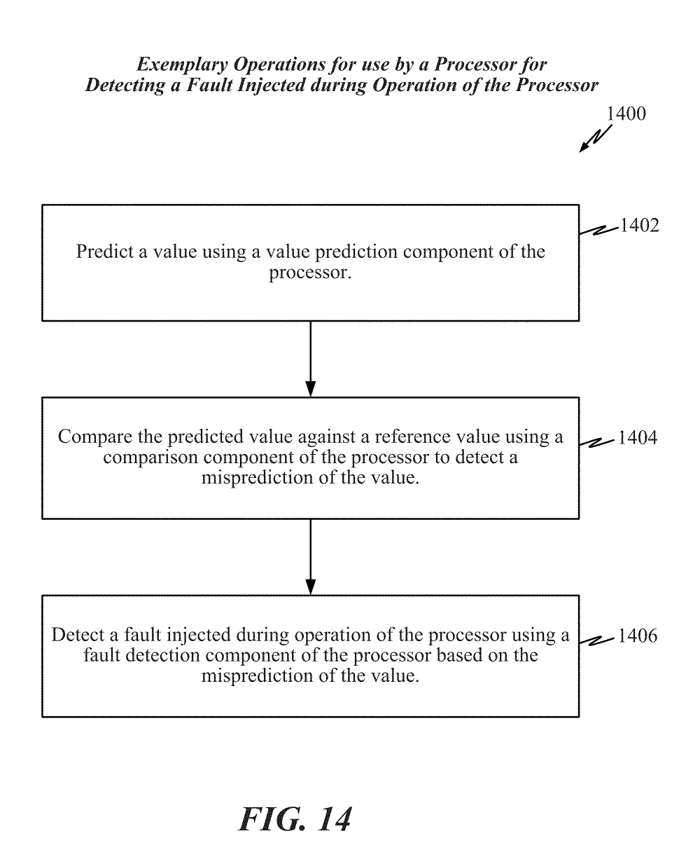

FIG. 14 broadly illustrates and summarizes methods or procedures 1400 that may be performed by suitably equipped processing devices or components for detecting a fault injected during operation of a processor. Briefly, at 1402, the processor predicts a value using a value prediction component of the processor. At 1404, the processor compares the predicted value against a reference value using a comparison component of the processor to detect a misprediction of the value. At 1406, the processor detects a fault injected during operation of the processor using a fault detection component of the processor based on the misprediction of the value. These features are described in detail in the examples discussed above.

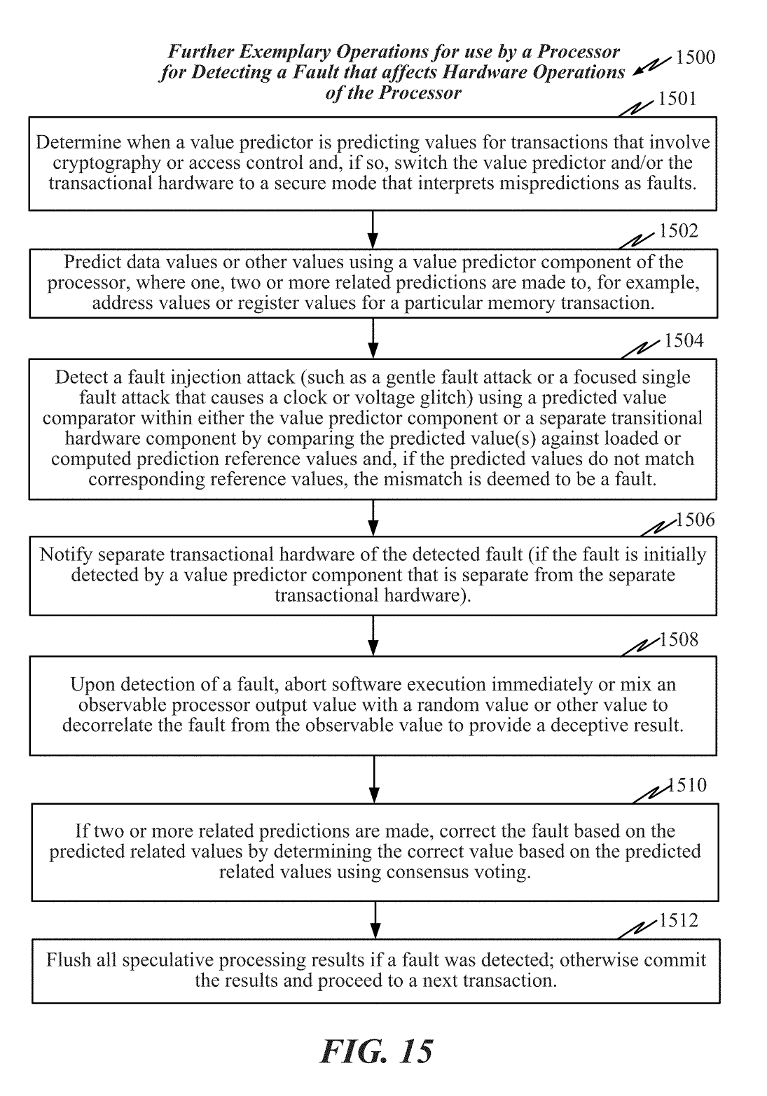

FIG. 15 further illustrates and summarizes methods or procedures 1500 that may be performed by suitably equipped processing devices or components for detecting a fault that affects hardware operations of a processor and for processing the detected fault. Briefly, at 1501 the processor determines or identifies when a value predictor is predicting values for transactions that involve cryptography or access control and, if so, the processor switches the value predictor and/or the transactional hardware to a secure mode that interprets mispredictions as faults. At 1502, a data values or other values are predicted using a value predictor component of the processor, where one, two or more related predictions are made to, for example, address values or register values for a particular memory transaction. At 1504, a fault injection attack (such as a gentle fault attack or a focused single fault attack that causes a clock or voltage glitch) is detected using a predicted value comparator within either the value predictor component or a separate transitional hardware component by comparing the predicted value(s) against a loaded or computed reference values and, if the predicted values do not match corresponding reference values, the mismatch is deemed to be a fault. At 1506, the separate transactional hardware is notified of the detected fault (if the fault is initially detected by a value predictor component that is separate from the transactional hardware). At 1508, upon detection of a fault, the processor aborts software execution or mixes an observable processor output value with a random value to decorrelate the fault from the observable value to provide a deceptive result. At 1510, if two or more related predictions are made, the processor corrects the fault based on the predicted related values by determining the correct value based on the predicted related values using consensus voting. At 1512, the processor flushes all speculative processing results if a fault was detected and otherwise commits the results and proceeds to a next transaction.

Note that, herein, the terms “obtain” or “obtaining” broadly cover, e.g., calculating, computing, generating, acquiring, receiving, retrieving, inputting or performing any other suitable corresponding actions. Note also that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features described herein can be implemented in different systems without departing from the aspects disclosed. It should be noted that the foregoing embodiments are merely examples and are not to be construed as limiting. The description of the embodiments is intended to be illustrative, and not to limit the scope of the claims. As such, the present teachings can be readily applied to other types of apparatuses and many alternatives, modifications, and variations will be apparent to those skilled in the art.

Moreover, in the following description and claims the terms “coupled” and “connected,” along with their derivatives, may be used. It should be understood that these terms are not intended as synonyms for each other. Rather, in particular aspects, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

Not all components, features, structures, characteristics, etc. described and illustrated herein need be included in a particular aspect or aspects. If the specification states a component, feature, structure, or characteristic “may,” “might,” “can” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In each figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be noted that, although some aspects have been described in reference to particular implementations, other implementations are possible according to some aspects. Additionally, the arrangement and/or order of circuit elements or other features illustrated in the drawings and/or described herein need not be arranged as illustrated and described. Many other arrangements are possible according to some aspects.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for detecting a fault injected during operation of a processor, comprising:
predicting a value using a value prediction component of the processor;
comparing the predicted value against a reference value using a comparison component of the processor to detect a misprediction of the value; and
detecting a fault injected during operation of the processor using a fault detection component of the processor based on the misprediction of the value.

2. The method of claim 1, further comprising mixing an observable output value with another value to decorrelate a detected fault from the observable output value.

3. The method of claim 2, wherein the observable output value is mixed with a random or pseudorandom number to provide a deceptive result.

4. The method of claim 1, further comprising aborting software execution if a fault is detected.

5. The method of claim 1, wherein predicting a value is performed to predict at least two related values and wherein the method further comprises correcting a detected fault based on the related values.

6. The method of claim 5, wherein correcting the detected fault based on the predicted related values comprises determining a correct value based on the predicted related values using consensus voting.

7. The method of claim 1, wherein the reference value is a loaded or computed value.

8. The method of claim 1, wherein the value predictor component includes the fault detection component and the processor has a transactional hardware component that is separate from the value predictor component, and wherein the value predictor component notifies the separate transactional hardware component of the fault.

9. The method of claim 1, wherein the processor has a transactional hardware component separate from the value predictor component and the transactional hardware component includes the fault detection component, and wherein detecting the fault is performed by the fault detection component of the separate transactional hardware.

10. The method of claim 1, wherein the fault affects a hardware operation of the processor.

11. A computing device, comprising:
a processing circuit configured to
predict a value,
compare the predicted value against a reference value to detect a misprediction of the value, and
detect a fault injected during operation of the processor based on the misprediction of the value.

12. The computing device of claim 11, the processing circuit is further configured to mix an observable output value with another value to decorrelate a detected fault from the observable output value.

13. The computing device of claim 12, the processing circuit is further configured to mix the observable output value with a random or pseudorandom number to provide a deceptive result.

14. The computing device of claim 11, the processing circuit is further configured to abort software execution if a fault is detected.

15. The computing device of claim 11, the processing circuit is further configured to predict at least two related values and to correct a detected fault based on the related values.

16. The computing device of claim 15, the processing circuit is further configured to correct the detected fault based on the predicted related values by determining a correct value based on the predicted related values using consensus voting.

17. The computing device of claim 15, wherein the processing circuit is configured to compare the predicted value against a reference value that is a loaded or computed value.

18. The computing device of claim 11, wherein the processing circuit includes a value predictor component and a separate transactional hardware component, and wherein the processing circuit is configured to detect the fault using the value predictor component and wherein the value predictor component is configured to notify the separate transactional hardware component of the fault.

19. The computing device of claim 11, wherein the processing circuit includes a value predictor component and a separate transactional hardware component, and wherein the processing circuit is configured to detect the fault using the separate transactional hardware component.

20. The computing device of claim 11, wherein the processing circuit is configured to detect a fault that affects a hardware operation of the processing circuit.

21. An apparatus for detecting a fault injected during operation of a processor, comprising:
means for predicting a value;
means for comparing the predicted value against a reference value to detect a misprediction of the value; and
means for detecting a fault injected during operation of the processor based on the misprediction of the value.

22. The apparatus of claim 21, further comprising means for mixing an observable output value with another value to decorrelate a detected fault from the observable output value.

23. The apparatus of claim 22, wherein the means for mixing includes means for mixing the observable output value with a random or pseudorandom number to provide a deceptive result.

24. The apparatus of claim 21, further comprising means for aborting software execution if a fault is detected.

25. The apparatus of claim 21, wherein the means for predicting a value includes means for predicting at least two related values and where the apparatus further comprises means for correcting a detected fault based on the related values.

26. The apparatus of claim 25, wherein the means for correcting the detected fault based on the predicted related values comprises means for determining a correct value based on the predicted related values using consensus voting.

27. The apparatus of claim 25, wherein the reference value is a loaded or computed value.

28. The apparatus of claim 21, wherein the processor has a value predictor component and a separate transactional hardware component, and wherein the means for detecting the fault is a component of the value predictor component and wherein the value predictor component notifies the separate transactional hardware component of the fault.

29. The apparatus of claim 21, wherein the processor has a value predictor component and a separate transactional hardware component, and wherein the means for detecting the fault is a component of the separate transactional hardware component.

30. A non-transitory computer readable medium having instructions stored thereon for controlling a processor to:
predict a value using a value prediction component of the processor;
compare the predicted value against a reference value using a comparison component of the processor to detect a misprediction of the value; and
detect a fault injected during operation of the processor using a fault detection component of the processor based on the misprediction of the value.
